(19) United States
(12) Patent Application Publication
(10) Pub. No.: US 2004/0083395 A1
(43) Pub. Date: Apr. 29, 2004

(54) Client-centric e-health system and method with applications to long-term health and community care consumers, insurers, and regulators

(76) Inventor: Elain Blechman, Boulder, CO (US)

Correspondence Address: Eugene Lieberstein, 2151 Long Ridge Road, Stamford, CT, 06903, US

(21) Appl. No.: 10/431,845

(22) Filed: May 8, 2003

Related U.S. Application Data
(63) Continuation-in-part of application No. 10/210,127, filed on Aug. 1, 2002.

(51) Int. Cl. G06F 7/00; G06F 17/30; H04L 9/00; H04K 1/00; H04L 9/32; G06F 11/30; G06F 12/14

(52) U.S. Cl. 713/202; 713/184; 707/1

(57) ABSTRACT

A web-based method and system for controlling access to a client-centric relational computer database containing records of named client accounts comprising the steps of: establishing an identity for each client account user to access the relational database via the Internet represented by an assigned ID and password under the control of the client; establishing authorization records for each authorized user of an identified client which defines the access and data function privileges for such authorized user in one or more named client accounts with such records being under the control of the client or its designated agent; authenticating an authorized user when accessing the relational database via the Internet by the assigned ID and password; and opening a limited account user interface in response to when said relational database is accessed by an authorized user such that access is limited only to data function privileges and operations defined in the authorization records.

### FIELD OF THE INVENTION

The present invention is a continuation in part of U.S. patent application Ser. No. 10/210,127 filed Aug. 1, 2002 and relates to unique client-centric, multi-level, multi-discipline, e-health system (hereinafter “eSystem”) and method.

### BACKGROUND OF THE INVENTION

Long-term healthcare consumers.

Each person is a long-term healthcare consumer, receiving healthcare services from a changing array of providers and enterprises across the lifespan. The highest-volume consumers of long-term healthcare are the elderly and people with chronic illnesses and disabilities-such as Alzheimer's, asthma, autism, cystic fibrosis, cognitive and developmental disabilities, diabetes, multiple sclerosis, schizophrenia, and spinal cord injury. Regardless of physical or mental status, every consumer is entitled to long-term healthcare in the least restrictive environment with an optimal quality of life for them and the least burden for their family caregivers. Long-term healthcare consumers deal with vast, uncoordinated, ever-changing arrays of providers (e.g., ambulance drivers, dieticians, home healthcare assistants, medical technicians, nurses, pharmacists, physical therapists, physicians, psychologists, religious leaders, social workers) and enterprises (e.g., clinical research organizations, hospitals, hospices, insurance companies, Medicare/Medicaid authorities, mental health centers, nonprofit and religious organizations, pharmaceutical companies, state and federal regulatory agencies). Few long-term healthcare clients or family caregivers have explicit knowledge of all the providers and enterprises that see their records, decide about authorization of expensive procedures, establish and follow through on treatment plans. No existing technology offers a cost-effective means of facilitating client-centric teamwork among geographically remote and organizationally independent providers and enterprises. Not surprisingly, a large body of evidence documents inadequacies in service delivery to long-term healthcare consumers including fatal mistakes.

Community-care consumers.

Many people (including long-term healthcare consumers) receive services intended to prolong community residence and prevent congregate care in a hospital, nursing home, or prison. The highest volume consumers of community care (aside from the previously described long-term healthcare consumers) are youths at risk for violence or suicide; juvenile and adult criminal offenders; and substance abusers. These consumers and their family caregivers require community-based services that effectively balance individual rights and public safety. Congregate care outside the community in alternative schools, residential treatment facilities, psychiatric hospitals, boot camps, and prisons multiplies costs to taxpayers, while diminishing individual rights and endangering the public. Community-care consumers constantly deal with vast, uncoordinated, ever-changing arrays of providers. Community-care providers include district attorneys, judges, lawyers, nurses, pharmacists, parole and probation officers, physicians, police officers, religious leaders, school psychologists, school principals, social workers, teachers, therapists. Community-care consumers also deal with vast, uncoordinated, ever-changing sets of enterprises. Community-care enterprises include child protective service agencies, clinical research organizations, halfway houses, homeless shelters, hospitals, hospices, insurance companies, Medicare/Medicaid authorities, mental health centers, nonprofit and religious organizations, pharmaceutical companies, prisons, school systems, sex offender registry, state and federal regulatory agencies, substance abuse testing and treatment centers. Few community-care clients or family caregivers have explicit knowledge of all the providers and enterprises that see their records, decide about foster care placement, choose between in-school suspension and alternative schooling, advise judges, decide about authorization of medical procedures, establish and follow through on treatment and court orders. No existing technology offers a cost-effective means of facilitating client-centric teamwork among geographically remote and organizationally independent providers and enterprises. Not surprisingly, a large body of evidence documents inadequate delivery of community-care to at-risk youths who later commit school shootings and parent murders, and to at-risk adults who later commit child neglect, abuse, and murder.

Common dilemmas in long-term healthcare and community care.

Common dilemmas in long-term health care and community care include fragmented service delivery, medical mistakes and malpractice, poor outcomes related to morbidity, mortality, rehospitalization, repeat institutionalization, recidivism, client abuse and neglect, inadequate consumer and family involvement, and fraudulent billing.

Enterprise-centric software platforms represent conventional technology and have been marketed to long-term healthcare and community care providers and enterprises. Enterprise-centric software is fundamentally incapable of resolving the common dilemmas that cripple the cost-effective delivery of long-term healthcare and community care. In fact, enterprise-centric software perpetuates these common dilemmas. The consumers of long-term healthcare and of community-care deal with vast, uncoordinated, ever-changing array of providers and enterprises that rely on diverse enterprise-centric software. With conventional technology, all the computer-literate providers and enterprises related to one client are using different, unrelated, uncommunicative enterprise-centric systems. Clients' records once resided in many different provider and enterprise filing cabinets, now they reside in many different filing cabinets and on many different provider and enterprise servers. With conventional technology, no one can quickly access all of a client's records in one place, search all these records, or relate one record to one event in the client's history and treatment plans. This is only one example of the insufficiency of conventional technology.

The eSystem of the present invention is designed to resolve common dilemmas in the field of long-term healthcare and community care that plague consumers, healthcare providers and enterprises, health and malpractice insurers, and entities that regulate healthcare accreditation and financing. While resolving these dilemmas, the eSystem is designed to surpass the performance of conventional enterprise-centric systems.

### SUMMARY OF THE INVENTION

The present invention is a client-centric e-health system (hereinafter “eSystem”) and method with applications to long-term health and community care consumers, insurers, and regulators. The invention is designed to resolve common dilemmas in long-term healthcare and community care. The invention is also designed to overcome shortcomings of the conventional technological approach to long-term healthcare and community care.

The eSystem employs account user interfaces, programming logic, a relational database, and client and superset accounts to achieve its goals. The system—programming logic encodes client-specified user privileges and controls the users' exercise of their privileges via the user interface on records stored in the relational database on a computer which is accessible via the Internet in a conventional manner. The unique features of the invention include multi-level, multi-user data access, data integration, data permanence, data privacy, and data portability for applications to long-term health and community care consumers, healthcare providers and enterprises, health and malpractice insurers, and entities that regulate healthcare accreditation and financing.

The programming logic is used as a software engine to operate the eSystem applying business rules to perform its methodology. For example, the eSystem uses business rules that restrict a user's client account access to data categories authorized by the account's legal agent. When a user logs on and enters an account, the client account user interface displays only data categories in the relational database for which the user has authorized access. The software engine drives the dynamic flow of information back and forth between client account and superset account user interfaces, the relational database, and client and superset accounts that reference relevant database tables. The software engine allows any number of authorized users to simultaneously access any number of data categories and data functions in client and superset accounts.

Definitions of terms.

Definitions of key terms as used in this patent specification and claims to understand the subject invention are listed below:

Client account.

Each consumer has a client account in the eSystem relational database. Either the consumer (the named client on the account) or the consumer's legal agent (e.g., parent, legal guardian, client-designated family caregiver) authorizes user access to the account and defines each user's access privileges to selected data categories and data functions in the client account. Authorized client account users consistent with their privileges may access a variety of data categories (e.g., criminal, educational, health insurance, legal, medical, mental health, occupational, substance abuse) and then perform a variety of data functions (e.g., view, search, update, edit, save, retire, aggregate, and restore).

Client-account user interface.

When an authorized user on an eSystem client account logs on to the eSystem with a valid logon ID and password, the eSystem displays user interface or Web pages consistent with the user's access privileges and preferences. The user interface page includes buttons, data-entry fields, and other devices that allow the user to exercise authorized privileges within the account. These privileges permit users to view, search, update, edit, save, retire, aggregate, and restore information. For example, FIG. 3 is illustrative of this and displays a series of buttons at the left from “My Home” at the top left to “Emergency Procedures” at the bottom left. Each button corresponds to a data category. The user who accessed this page has privileges related to each of these data categories. Users with lesser privileges would see fewer buttons on the left of this interface page. FIG. 3 displays an “Add New Record” button below the schedule. This button corresponds to a data function, adding an event to the schedule. The user who accessed this page has privileges related to this function. Users with lesser privileges might be able to view the schedule page but would not have access to the “Add New Record” button.

Client-centric system.

In a client-centric system, consumers regulate access to their personal information in their client accounts.

Consumer.

The consumer is an individual who is a recipient of long-term healthcare or community care services or that individual's family caregiver.

Data categories.

Each consumer of long-term healthcare or community care services is associated with a body of information about the consumer's need for services, the nature of services, the cost of services, the process, and outcome of services. This body of information grows over time. This body of information can be broken down into criminal, educational, health insurance, legal, medical, mental health, occupational, substance abuse, and other data categories (or types of information). The eSystem user interface is organized around these data categories. In the user interface page displayed in FIG. 3, there is a button at the left for multiple data categories from “My Home” at the top to “Emergency Procedures” at the bottom. The user clicks on a data category button to open related pages in the user interface. To open the schedule page displayed in FIG. 3, the user has clicked on the “Schedule” button. Only a user with authorized access to the schedule data category sees the schedule button on the left.

Data functions.

Each consumer of long-term healthcare or community care services is the associated with a body of information about the consumer's need for services, the nature of services, the cost of services, the process, and outcome of services. This body of information grows over time. This body of information can be broken down into auditing, health insurance transactions, prescription writing, report generation, tracking, scheduling, and other data functions (or operations on information). In the eSystem user interface, data functions are organized within data categories. In the user interface page displayed in FIG. 3, there is an “Add New Record” below the schedule. The user clicks on this button to add an event to the schedule. Only a user with schedule update privileges sees the “Add New Record” button.

Enterprise.

An enterprise is an organization such as a clinic, clinical research organization, emergency room, health-maintenance organization, hospital, juvenile court, nursing home, prison, or school system. The enterprise coordinates the efforts of multiple practitioners who provide counseling, detention, educational, emergency response, healthcare, insurance transactions, judicial, law enforcement, medical, mental health, supervision, training, or other services to multiple consumers.

Enterprise-centric system.

In an enterprise-centric system, the enterprise regulates access to consumers' personal information.

Multi-discipline.

The eSystem has a multi-discipline user interface. When authorized users from different disciplines (e.g., medicine, mental health) logon to the eSystem and enter a client account, they each have selective access to data categories (e.g., medicine, mental health) and data functions (e.g., prescription writing, psychological assessments) consistent with their disciplines.

Multi-level.

The eSystem has a multi-level user interface. When authorized users from different levels (e.g., consumer, provider, enterprise representative) logon to the eSystem, each sees a personalized user home page with a selective list of accessible accounts (e.g., consumer's own client account; a client account for each of the provider's patients; a provider account for each enterprise provider). For example, FIG. 4 is illustative of the user home page for a fictional provider, Judy Burge in a multi-level user interface. A “Current Clients” drop-down menu at the center of the page allows Judy to select a client, perhaps Bonnie, and then open Bonnie's client account by clicking the “See Client” button at the right. Provider and enterprise accounts represent superset accounts. The user can click on an accessible account in the list and depending upon access privileges assigned by the client account's legal agent, the user can drill down to specific data categories (e.g., medicine, mental health) and use specific data functions (e.g., prescription writing, psychological assessments, data export, report generation) in one client account. A superset account user can also employ one data function (e.g., report generation) and aggregate across subordinate accounts (e.g., to compile a record of providers' writing of prescriptions for narcotics broken down by clients' gender, ethnicity, age, and health insurance carrier.

Network.

A network may be a health or malpractice insurance carrier, a state or federal regulatory agency, a private or public grant-making entity. A network connects multiple enterprises, each coordinating multiple practitioners who provide services to multiple consumers.

Provider.

A provider is a practitioner in fields such as education, healthcare, law enforcement, medicine, nursing, psychology, or social work, who offers services to multiple consumers.

Relational database.

The eSystem relational database includes data tables for each data category and data function. Other tables define matters such as users' authorization privileges and relationships between accounts. An eSystem client account (for Client #1000) includes the rows in each data category and table related to Client 1000. An eSystem superset account (Provider 2545) references the rows in each data category and table related to all subordinate accounts (Provider 2545's authorized client accounts).

Superset account.

Providers, enterprises, and networks have superset accounts in the eSystem relational database. The named client or legal agent on associated client accounts defines access privileges on superset accounts. Consistent with their privileges, authorized superset account users may selectively access one or more associated client accounts. They may open one or more data categories within selected client accounts (e.g., criminal, educational, health insurance, legal, medical, mental health, occupational, substance abuse). Finally, they may perform a variety of data functions within or across selected data categories (e.g., view, search, update, edit, save, retire, aggregate, restore). In one scenario, access privileges allow a provider's business associates to view and update identified data in the client account (e.g., the social worker's clinical supervisor). In a second scenario, access privileges allow an enterprise's employee (e.g., insurance company medical director) to view and update specified data in the client account (e.g., health insurance transactions related to an August 2002 auto accident). In a third scenario, access privileges allow a network representative (e.g., director of a state child welfare agency) to receive alerts triggered when network enterprises (e.g., social service agencies) and network providers (e.g., case workers) fail to adhere to procedural guidelines (e.g., submit weekly reports on home visits to abused children returned to the home of a previously abusive parent). In general, a superset account user can employ one data function (e.g., search) and aggregate across associated accounts (e.g., to identify doctors broken down by percent compliance with professional practice guidelines for prescription of narcotics to minors).

Superset account user interface.

When an authorized user on an eSystem superset account logs on to the eSystem with a valid logon ID and password, the eSystem displays user interface or Web pages consistent with the user's access privileges and preferences. These privileges permit users to view, search, update, edit, save, retire, aggregate, and restore information. For example, In FIG. 4 the fictional provider, Judy Burge, is authorized on multiple client accounts. A “Current Clients” drop-down menu at the center of the page allows Judy to select a client, perhaps Bonnie, and then open Bonnie's client account by clicking the “See Client” button at the right. What Judy can do once she enters Bonnie's account depends upon the data category and data function privileges that Bonnie defined for her.

### BRIEF DESCRIPTION OF THE DRAWINGS

FIG. 1 depicts the invention's system and method in respect to one client account;

FIG. 2 depicts the invention's system and method in respect to multiple client accounts;

FIG. 3 is a screen shot of one client account user interface page;

FIG. 4 is a screen shot of one superset account user interface page;

FIG. 5 consists of FIG. 5a which is a conventional enterprise-centric system and FIG. 5b showing a client-centric user integration system of the present invention;

FIG. 6 similarly includes FIG. 6a and FIG. 6b to contrast the conventional enterprise-centric system of FIG. 6a vs. the consumer privacy client-centric system FIG. 6b of the present invention;

FIG. 7 similarly includes FIG. 7a and FIG. 7b to contrast the conventional enterprise-centric system of FIG. 7a vs. the client-centric system FIG. 7b of the present invention which includes data category integration;

FIG. 8 similarly includes FIG. 8a and FIG. 8b to contrast the conventional enterprise-centric system of FIG. 8a vs. the client-centric system FIG. 8b of the present invention which includes time-dependent data integration;

FIG. 9 shows the invention's escalating alert feature;

FIG. 10 shows the invention's document retrieval feature;

FIG. 11 shows the invention's data permanence feature;

FIG. 12 shows the invention's hardware and infrastructure architecture;

FIG. 13 includes FIG. 13a and FIG. 13b to contrast the conventional enterprise-centric system of FIG. 13a vs. the client-centric system FIG. 13b of the present invention relative to handling health insurance transactions;

FIG. 14 shows the invention's coordinated assessment and referral feature; and

FIG. 15 shows the invention's coordinated case management feature.

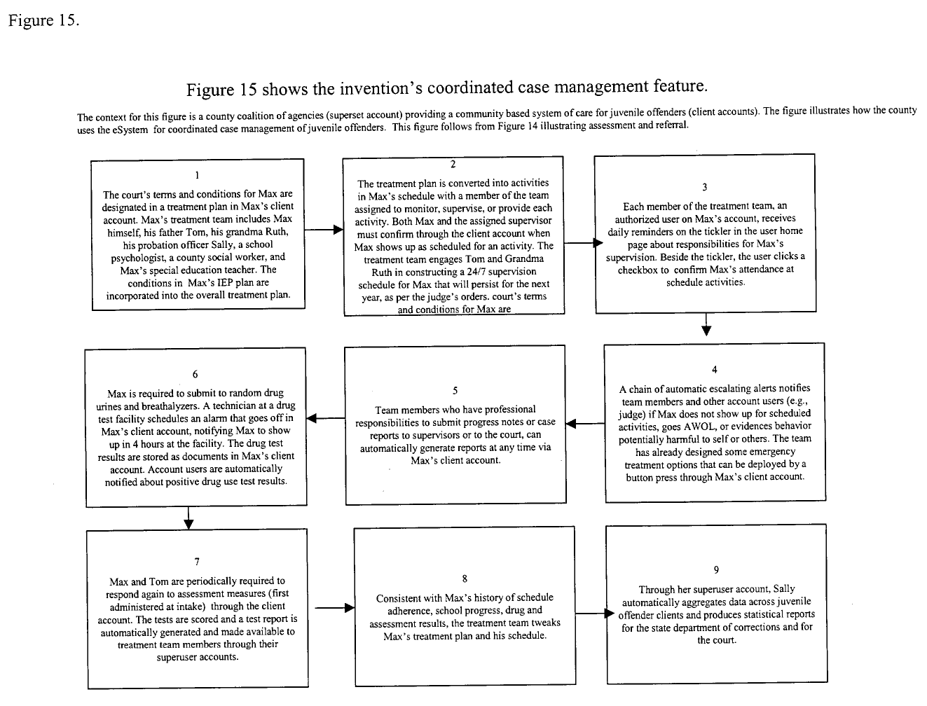

### DESCRIPTION OF THE PREFERRED EMBODIMENT

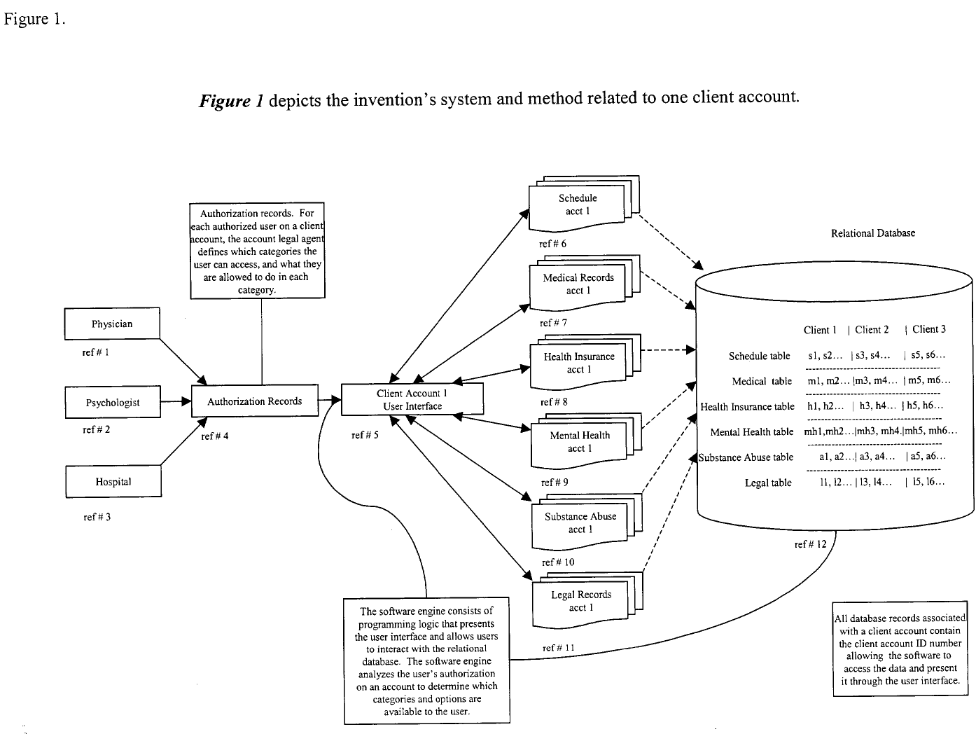

The system of the present invention is illustrated in FIG. 1 showing a client account user interface (ref# 5), a relational database (ref# 12), and a client account composed of multiple data category records (ref# 6-11). The method of the present invention uses programming logic to encode client-specified user privileges into authorization records (ref# 4). This logic controls users' (ref# 1-3) exercise of their privileges in the client account via the user interface (ref# 5) on records (ref# 6-11) in the relational database (ref# 12).

For purposes of this example, client account 1 relates to a morbidly obese patient with chronic low-back pain (treated by a neurologist, ref# 1), an eating disorder (treated by a psychologist, ref# 2), and a history of two triple bypass operations (performed by a cardiologist, ref# 3). The three authorized users (ref# 1-3) on client account 1 each logon at 4:30 p.m. on August 5^{th} but from different geographical locations. They do this by entering the system's website address into any device equipped with an Internet browser. Once on the Website, each user enters a logon ID and password in user interface fields requesting this information. The programming logic searches authorization records (ref# 4) in the relational database (ref #12) to determine each user's access privileges and opens a client account user interface (ref #5) that supports client-defined access privileges to data categories and data functions within categories. In this figure, the three authorized users have all privileges (including view, edit, update, retire, restore) on all data categories in the client account (ref #6-11). Each user exercises these privileges via devices in the user interface (ref# 5) such as buttons that when clicked, open data category pages or perform data functions.

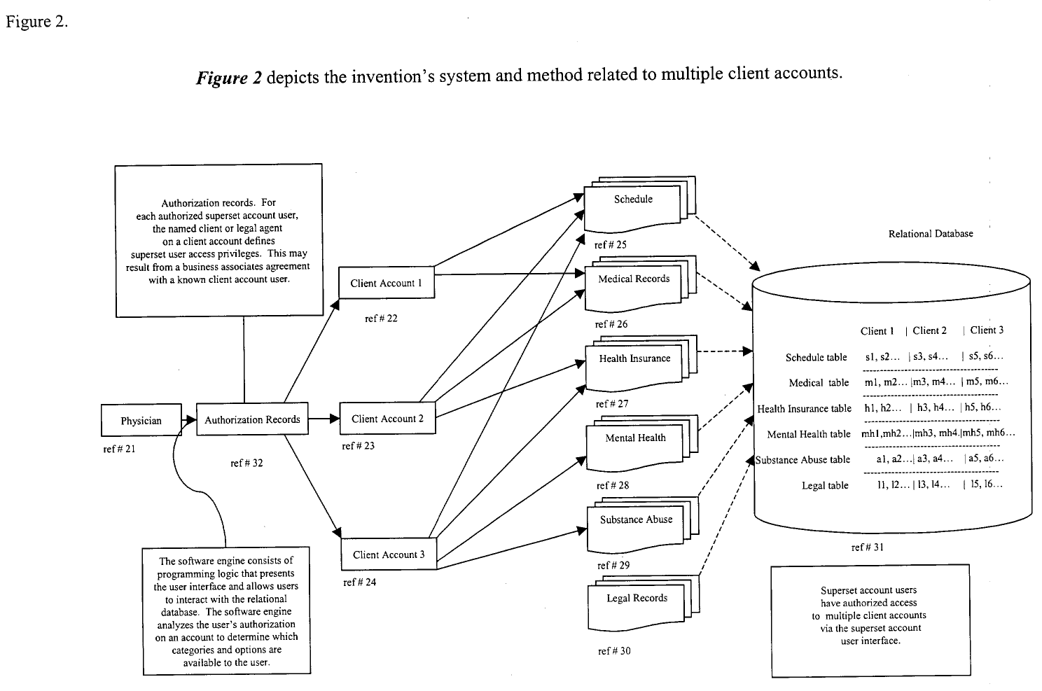

FIG. 1 depicted the invention's system in relationship to one client account. FIG. 2 depicts a scenario in which a physician is authorized on multiple client accounts through a superset account user interface (ref# 21) consistent with authorization records (ref# 32) that specify the superset user's specific client-authorized access privileges on multiple client accounts (ref# 22-24) each comprising multiple data category records (ref# 25-30) residing in a relational database (ref# 31). The invention's method uses programming logic to encode client-specified user privileges into authorization records (ref# 32) and to control the user's (ref# 21) exercise of access privileges across multiple client accounts (ref# 22-24) each with records (ref# 25-30) in the relational database (ref# 31).

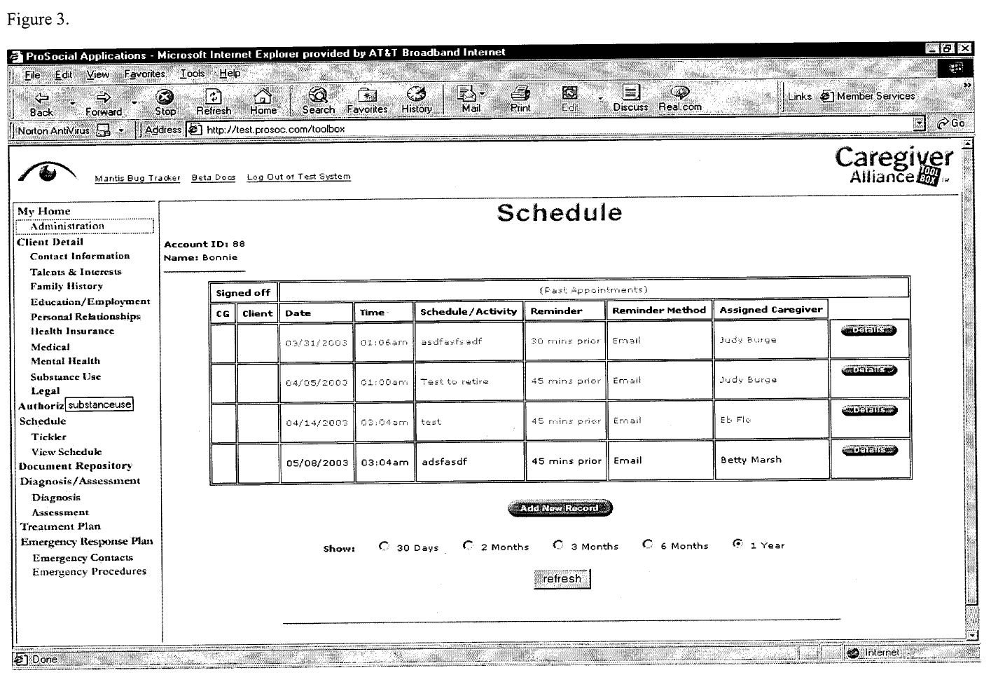

When an authorized user on an eSystem client account logs on to the eSystem with a valid logon ID and password, the eSystem displays user interface or Web pages consistent with the user's access privileges and preferences. FIG. 3 is a screen shot of one client account user interface page. The user interface page includes buttons, data-entry fields, and other devices that allow the user to exercise authorized privileges within the account. These privileges permit users to view, search, update, edit, save, retire, aggregate, and restore information. For example, FIG. 3 displays a series of buttons at the left from “My Home” at the top left to “Emergency Procedures” at the bottom left. Each button corresponds to a data category. The user who accessed this page has privileges related to each of these data categories. Users with lesser privileges would see fewer buttons on the left of this interface page. FIG. 3 displays an “Add New Record” button below the schedule. This button corresponds to a data function, adding an event to the schedule. The user who accessed this page has privileges related to this function. Users with lesser privileges might be able to view the schedule page but would not have access to the “Add New Record” button.

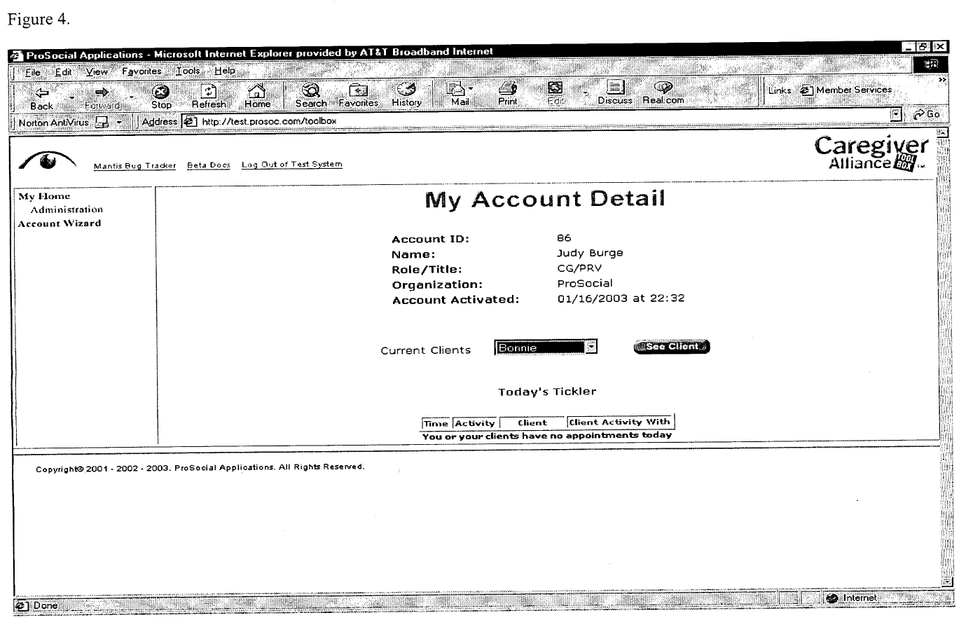

When an authorized user on an eSystem superset account logs on to the eSystem with a valid logon ID and password, the eSystem displays user interface or Web pages consistent with the user's access privileges and preferences. These privileges permit users to view, search, update, edit, save, retire, aggregate, and restore information. For example, FIG. 4 shows a user home page for a fictional provider, Judy Burge who is authorized on multiple client accounts. A “Current Clients” drop-down menu at the center of the page allows Judy to select a client, perhaps Bonnie, and then open Bonnie's client account by clicking the “See Client” button at the right. What Judy can do once she enters Bonnie's account depends upon the data category and data function privileges that Bonnie defined for her.

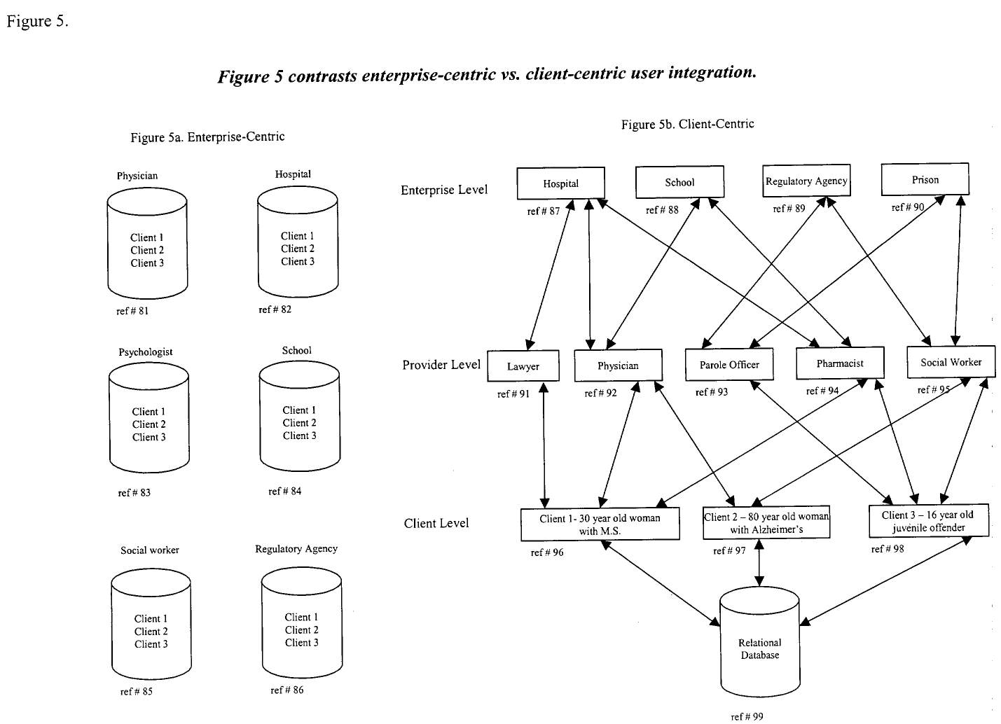

FIG. 5a illustrates conventional enterprise-centric data integration. Three providers (ref #81, 83, 85) and three enterprises (ref #82, 84, 86) each have their own enterprise-centric database (ref #81-86). The lack of connection between enterprise-centric databases (ref #81-86) precludes information sharing or coordination among providers and enterprises providing overlapping services to Clients 1, 2, and 3.

FIG. 5b illustrates the invention's unique client-centric multi-level, multi-discipline user integration feature, an expression of the invention's unique system and methods. FIG. 5b shows user integration across user levels (client, provider, enterprise) and across user disciplines (medicine, psychology, education, social work, regulatory compliance). FIG. 5b shows integrated information sharing and activity coordination among five providers (ref# 91-95) and four enterprises (ref# 87-90) providing overlapping services to three clients (ref# 96-98). One relational database (ref# 99), stores information in each client account so that it is accessible to a multi-level (provider, enterprise), multi-disciplinary (lawyer, physician), ever-changing array of authorized account users.

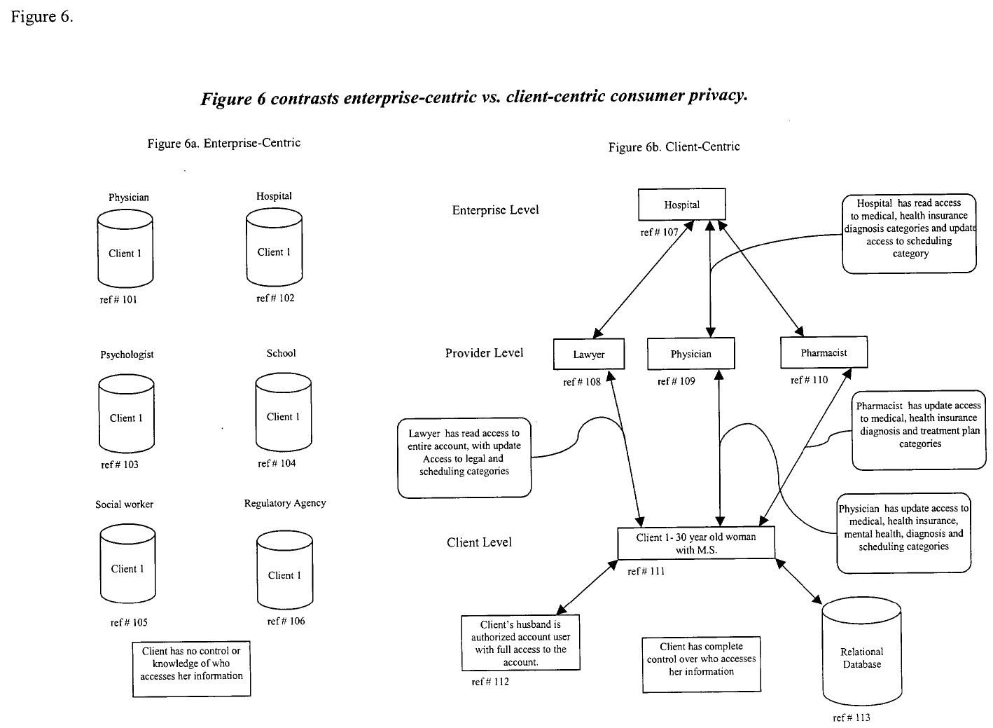

FIG. 6b illustrates the client-centric consumer privacy of the present invention. In this example, Client 1 is a 30-year-old woman with multiple sclerosis cared for by her husband.

For purpose of contrast FIG. 6a shows conventional enterprise-centric consumer privacy involving six independent enterprise-centric databases (ref# 101-106), each of which includes fragments of Client 1 healthcare information. The consumer (and her husband) do not know what personal information is in these databases. They exercise no control over users who access personal information in these databases. They do not know and cannot control users who view, update, or delete information in her records in any of these databases.

FIG. 6b shows one client-centric relational database (ref# 113). In the database is Client 1's client account (ref# 111) composed of all data categories of Client 1's healthcare information. Authorized enterprise (ref# 107), provider (ref# 108-110), and family caregiver (ref# 112) users differ in their access privileges to the client account. The client has complete control over user access to her client account.

She decides who is an authorized user, what data categories they see in the user interface, what data functions they employ within a data category. She can change these designations at any time.

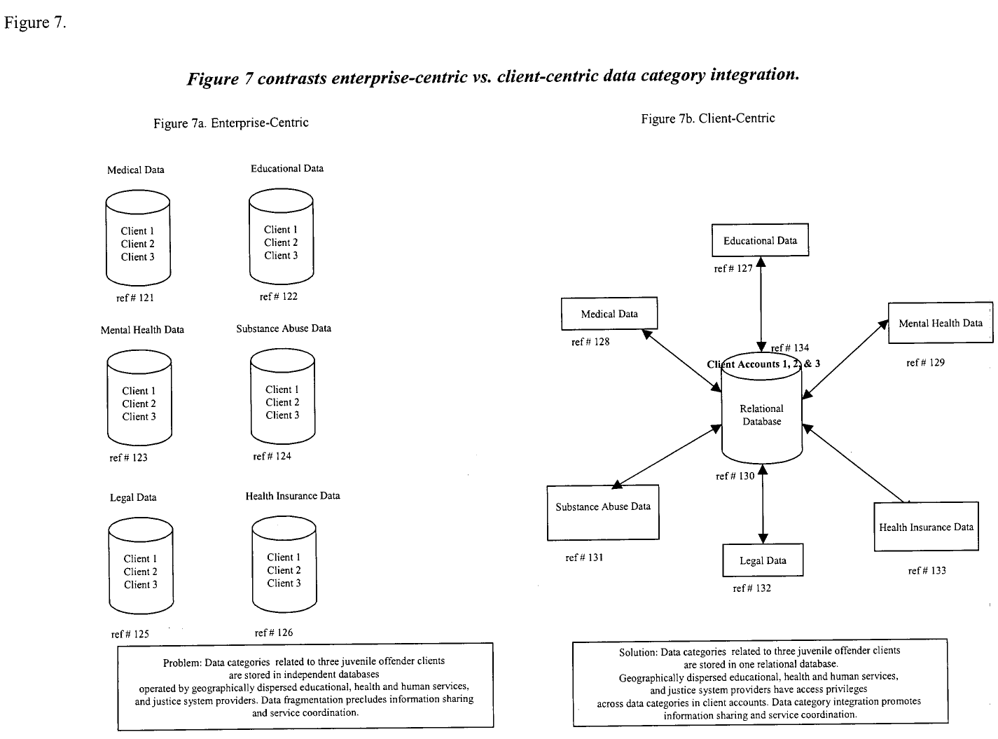

FIG. 7 contrasts enterprise-centric vs. client-centric data category integration. In this example, Clients 1, 2, and 3 are juvenile offenders on probation in the community. Each client receives services from geographically dispersed educational, health and human services, and justice system providers.

FIG. 7a shows conventional enterprise-centric data category integration involving six independent enterprise-centric databases (ref# 121-126). Each database is dedicated to a particular data category (e.g., legal data, medical data) and maintained by a provider (e.g., probation officer, doctor). Fragmented databases prevent geographically dispersed and organizationally unrelated providers from sharing information and coordinating service delivery.

FIG. 7b illustrates the invention's unique client-centric data category integration feature, an expression of the invention's unique system and methods. FIG. 7b shows one client-centric relational database (ref# 130) including three client accounts (ref# 134). Each client account comprises six data categories (ref# 127-132) to which all authorized users have access. Data category integration promotes sharing of information and coordination of service delivery among geographically dispersed and organizationally unrelated providers.

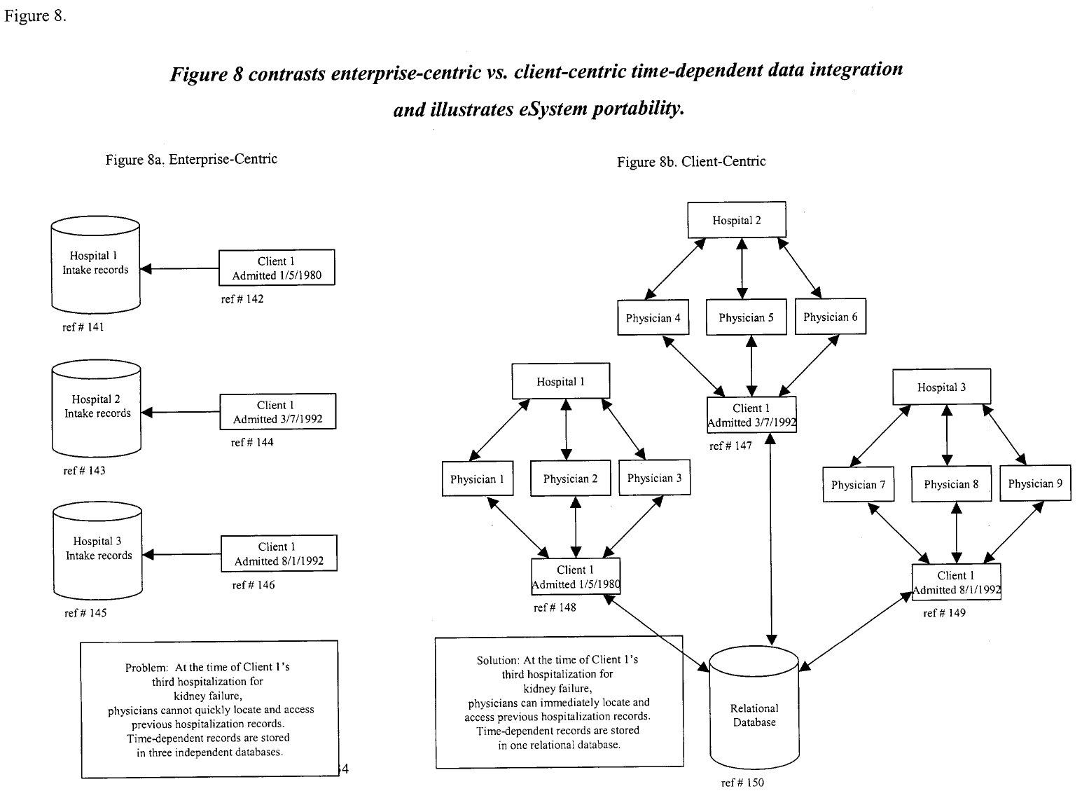

FIG. 8 shows the invention's portability and contrasts enterprise-centric vs. client-centric time-dependent data integration. In this example, Client 1 has been admitted at three different times to three different hospitals for kidney failure.

FIG. 8a shows conventional enterprise-centric time-dependent data integration. FIG. 8a shows three independent enterprise-centric databases (ref# 141, 143, 145) each operated by a hospital in California, Michigan, or Florida. In each database are records from admissions of Client 1 during kidney failure (ref #142, 144, 146) at a different time. Client 1 is unconscious when he is admitted for his third hospitalization (ref# 142). Physicians at Hospital 3 who examine and treat Client 1 have no way to locate or access previous time-dependent hospitalization records (ref# 142, 144) that are of critical importance to Client 1's recovery.

FIG. 8b illustrates the invention's unique client-centric time-dependent data integration feature, an expression of the invention's unique system and methods. FIG. 8b shows one relational database (ref# 150) integrating time-dependent records from three hospitals in California, Michigan, and Florida related to admission of Client 1 during kidney failure (ref #148, 147, 149). Client 1 is unconscious when he is admitted for his third hospitalization (ref# 149). Physicians 7, 8, and 9 who examine and treat Client 1 during his third admission (ref# 149) can immediately locate and access previous time-dependent hospitalization records (ref# 147, 148) that are of critical importance to Client 1's recovery.

FIG. 8b also illustrates the invention's portability feature, an expression of the invention's unique system and methods. As a consumer changes doctor's and hospitals, he can remove authorization from some account users and establish authorization for other account users. All this is accomplished without any loss of information in the client account.

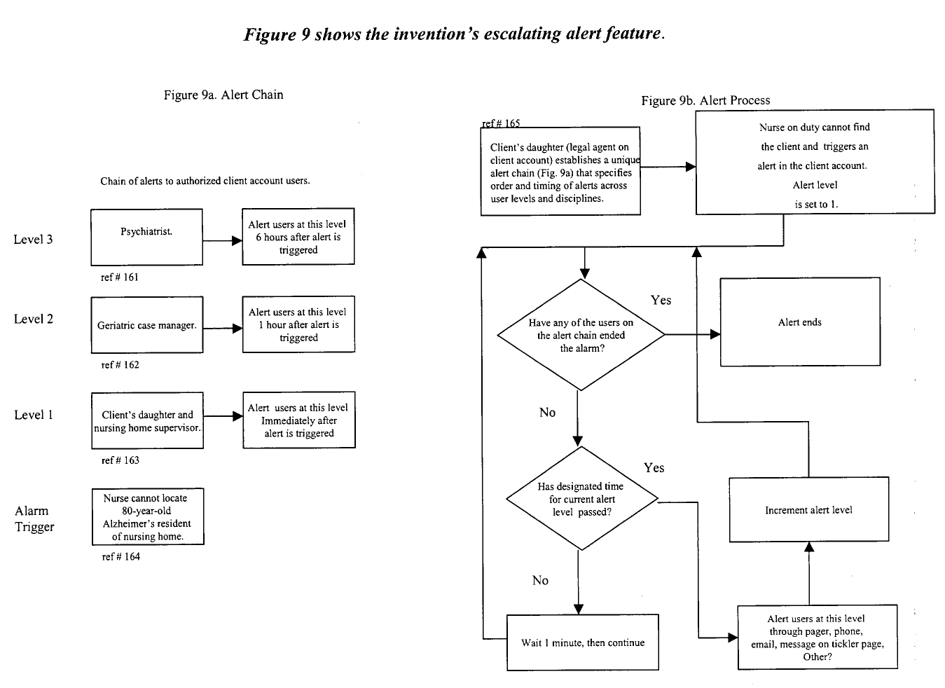

FIG. 9 shows the invention's escalating alert feature. In this example, the client is an 80-year-old Alzheimer's patient and nursing home resident. The escalating alert feature is possible only in a client-centric system that integrates users across levels and disciplines as depicted in FIG. 5.

This example shows how the alert chain works. As FIG. 9 shows, the alert chain (FIG. 9a) is triggered (ref# 164) when a nurse cannot locate an 80-year-old Alzheimer's resident of a nursing home. The client's daughter (legal agent on client account, ref #165) establishes a unique alert chain for her father's client account that is deployed via standard alert process shown in FIG. 9b. The alert chain in FIG. 9a specifies the unique order and timing of alerts issued via a standard alert process (FIG. 9b) across user levels (e.g., client's daughter, geriatric case manager, nursing-home supervisor) and disciplines (e.g., psychiatry, geriatric case management) (ref#161-164). The escalating alert feature is possible only in a client-centric system that integrates users across levels and disciplines as depicted in FIG. 5.

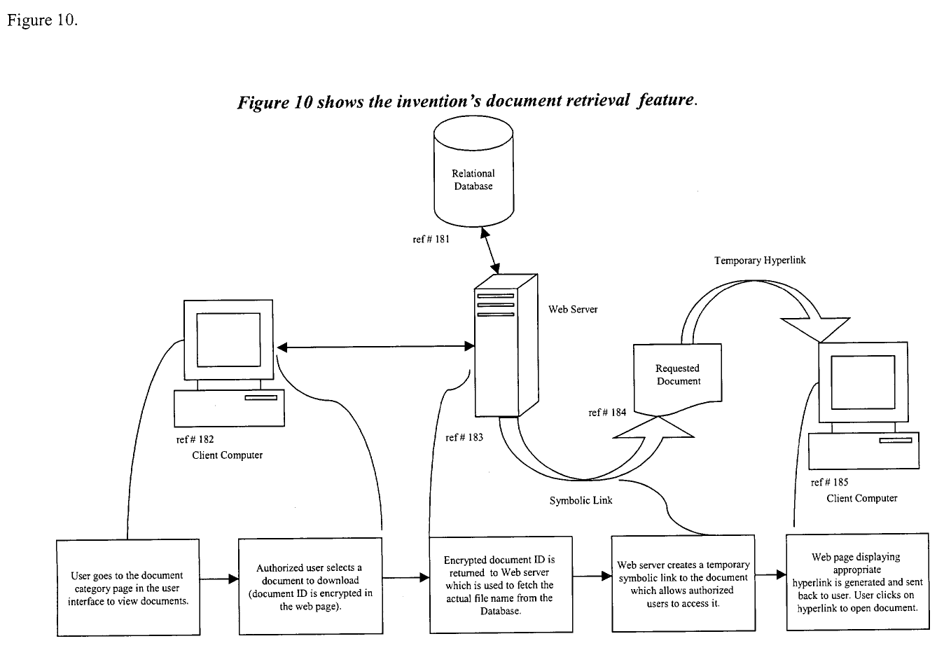

FIG. 10 illustrates the invention's unique document retrieval feature. The document retrieval feature is possible only in a client-centric system that establishes unique authorization privilege records to each data category in a client account for each account user as depicted in FIG. 1 and that protects consumer privacy as depicted in FIG. 6.

This example illustrates how the document retrieval feature works. An authorized account user in Boston (the client) stores his original documents (e.g., x-rays, living wills, and psychiatric evaluations) in relevant data categories within his client account (e.g., medical, legal, mental health). Later, another user in Detroit (the client's lawyer) uses his computer (ref# 182) to access the relevant document category page in the user interface and select a document (e.g., living will) to download. The encrypted document ID for the selected document is returned to the invention's Web server (ref# 183), which is used to fetch the actual file name from the relational database (ref# 181). The Web server (ref# 183) creates a temporary symbolic link to the requested document (ref# 184). The Web page displaying the appropriate hyperlink is generated and sent back to the user so that the client's lawyer in Detroit can access the requested document via his computer (ref# 185).

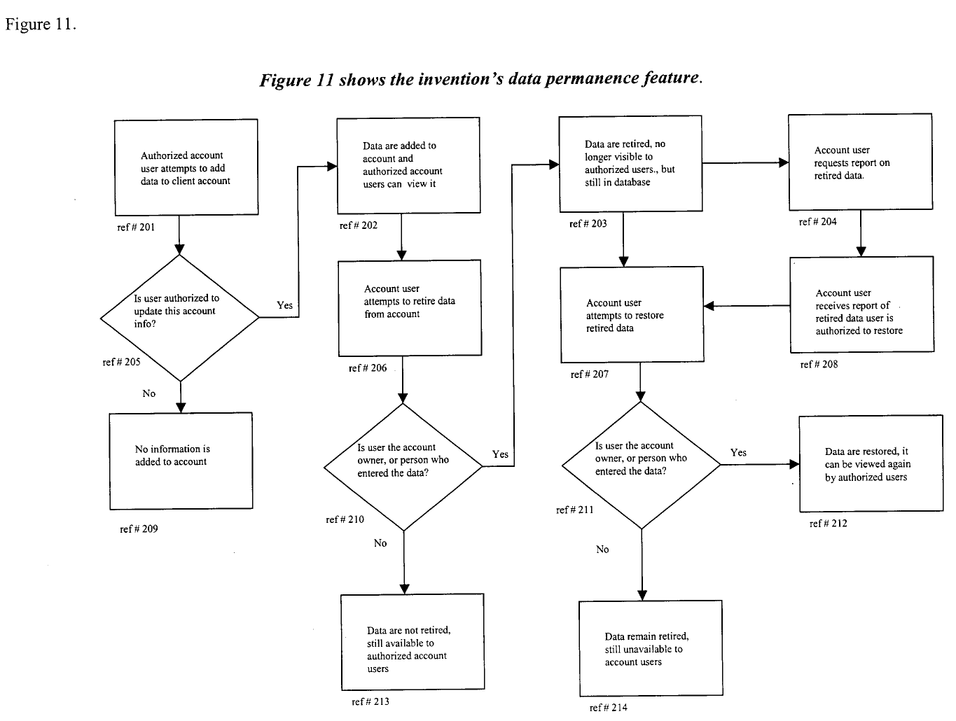

FIG. 11 illustrates the invention's unique data permanence feature. The data permanence feature is important for operation of a client-centric system that integrates information relevant to one client across data categories (FIG. 7), across users (FIG. 5), and across time (FIG. 8). With data permanence, the client account becomes an unquestionably objective and reliable repository of information about the sequence of activities of one or more authorized users and a solid foundation for the audit trail feature described in Example 1. Without data permanence, a nurse involved in a fatal medical mistake could delete pertinent information.

This is how the data permanence feature works. The eSystem's relational database includes business rules, shown in FIG. 11, to determine changes that can be made in client account information. The eSystem's programming logic checks the user's authorization record and presents a client account user interface consistent with user access privileges. In brief, here are the business rules related to data permanence. A user must be authorized to add information in a specified data category (ref# 205). Only the client account legal agent or person who entered data may retire data from the account to an archive (data are never deleted, can always be restored from archive, some data can never be retired) (ref# 213). Only the client account legal agent or person who entered data can restore the data to view (ref# 211).

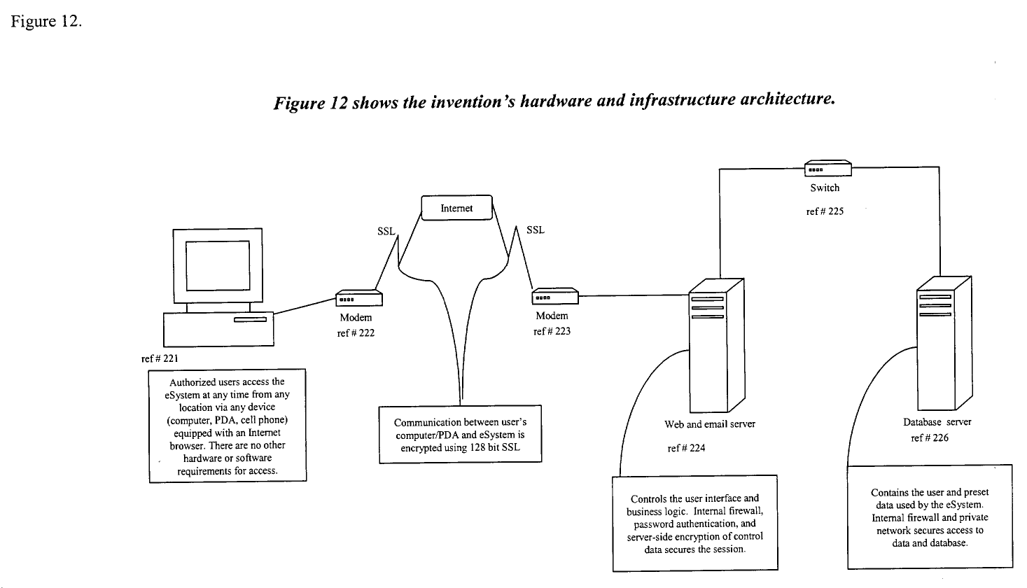

FIG. 12 shows the invention's hardware and infrastructure architecture comprising the user's Internet browser, modem equipped device (ref# 221), programming that encrypts communication between the user's device and the eSystem (ref# 222, 223), a Web and email server that controls the user interface and business logic (ref# 224), a switch (ref# 225) that connects to the database server (ref# 226).

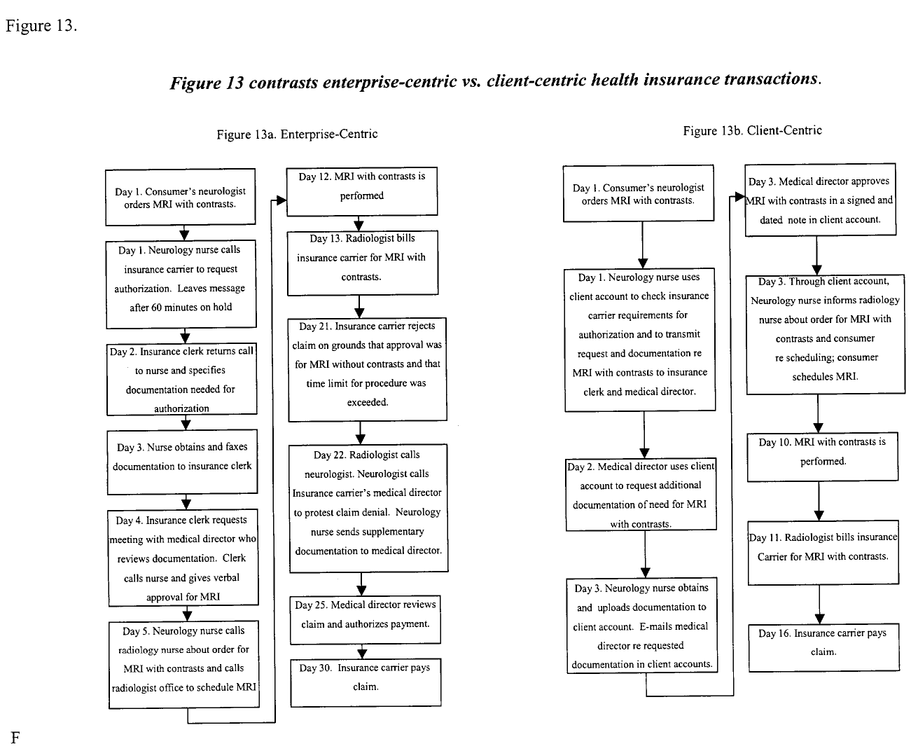

FIG. 13 contrasts enterprise-centric vs. client-centric health insurance transactions.

FIG. 13a illustrates conventional enterprise-centric health insurance transaction. With or without the support of an enterprise-centric medical records system, enterprise-centric health insurance transactions take longer, cost more money, and are fraught with more errors than the client-centric method. Most of the people involved in health insurance transactions, including clients and family caregivers, have no access to the enterprise-centric record system. The information needed for cost-effective health-insurance transactions is fragmented across record-keeping systems specific to data categories (FIG. 7), user levels and disciplines (FIG. 5), and time (FIG. 8).

FIG. 13b illustrates how cost-effective health insurance transactions are possible only in a client-centric system that integrates all of a client's healthcare information in one relational database across data categories (FIG. 7), users (FIG. 5), and time.

This is how the client-centric health insurance transaction works as illustrated in FIG. 13. A claims clerk at the health insurance carrier and the medical director are established as authorized users on the health insurance category of a customer's client account (and on no other data category). Following an electronic handshake between the client and the insurance carrier, the health insurance category of the client account receives an additional page branded with the company name “Safety Net Inc.” From this page, all authorized client account users can access the client's policy, the company's requirements for procedure certification, and Web page claims forms. Client and healthcare providers can fill in these Web page forms while in the client account, and submit them directly to the insurance company's payment agents and medical directors through their superuser account. Copies of the submission remain in the client account. All relevant parties are notified on their message boards about the submission. All transactions are tagged with the user ID. Given this permanent electronic identification, in documents and in audit trails, there is no need to download, sign, notarize, and upload documents for transmission. Documents involved in transactions are sent in permanent, read only, form. The insurance company rep can transmit information about claims into the account with automatic notification of all relevant account users and others with need to know who are not account users. Through the client account, the insurance carrier's medical director can request and receive documentation from account users such as the doctor's progress notes, requests for procedures, and accompanying documentation and test results. Through the client account, the insurance carrier can definitively inform account users about parameters of certification of requested procedures.

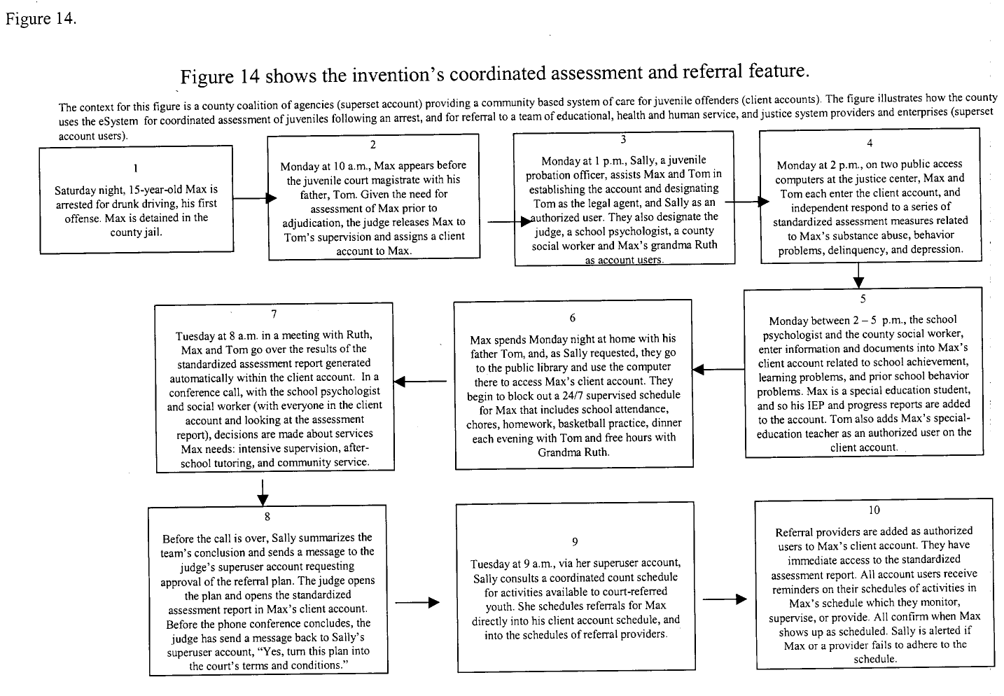

FIG. 14 shows the invention's coordinated assessment and referral feature.

In this example, Clients 1, 2, and 3 are juvenile offenders on probation in the community. Each client receives services from geographically dispersed educational, health and human services, and justice system providers.

### Example 1

Example 1 shows the invention 's client-centric audit trail feature.

Case Summary.

A 75-year-old male, Bob Jenkins, presents to a primary care doctor, Sam Siegel, complaining of intolerable back pain and exhibiting some disorientation. Pt does not know today's date and says, “I'm taking the fifth” when asked to identify the president of the United States. Pt. has just moved to Colorado from Minnesota to live with daughter Susan Jenkins who accompanied him to the doctor's office. Pt's daughter begs doctor to give her father some painkillers, stating that she will “leave him on a park bench,” otherwise. Nurse asks daughter and Pt about Pt's prior allergic reactions to meds. Neither mentions any. Doctor prescribes codeine, discusses possible contraindications (including prior adverse reaction) with Pt and daughter, and recommends that daughter consult a local geriatrician re possible diagnosis of Stage 1 Alzheimer's. Two days later, the daughter's attorney calls indicating that Pt has had adverse reaction to codeine and has been admitted to local community hospital via the emergency room. Daughter (per attorney) claims that she told the doctor about her father's prior allergic reaction to codeine and stated, “he almost died from it.”

Using the client account to prevent liability.

The primary care doctor's nurse assigns a client account to each new and existing patient. Either the named patient or the patient's designated family caregiver is assisted in setting up the account, providing information about vital healthcare information including current medications, allergies, and past and present medical conditions including allergic reactions. This vital healthcare information appears on the client home page when any user enters the account. The patient or family caregiver (legal agent on client account) authorizes the primary care doc as a user with full privileges in the medical data category. Prior to an office visit (either from a home computer or from a PC in the doctor's office, patient and/or family caregiver are required to: (1) review the client account home page and check a box indicating that all vital information is current, and (2) state the complaint(s) they want the doctor to address and the remedies they prefer. Before the doctor enters the exam room, he accesses the client account with own unique Logon ID and password (insuring that he leaves a footprint in the audit trail) and reads through the current statement of vital information and reason for office visit (leaving a trace in the audit trail of this action). In the exam room, once the doctor is ready to write a prescription for the patient, he accesses the client account via a pocket PDA. From inside the client account, he writes a prescription and sends it to the client's selected pharmacy for fulfillment. The patient or family caregiver receives a copy of the doctor's order on the message board in the user home page. The complete doctor's order may be sent later following transcription of doctor's dictation expanding upon aspects of the SOAP note that require patient and family caregiver understanding. When client or designated family caregiver open the message from the doctor, the audit trails registers this action. In most cases, usage of the client account in this fashion will prevent the kinds of situations that lead to malpractice claims.

Using the audit trail to minimize liability.

In the case summarized above, the same sequence of events might have occurred. Daughter and father could have reported no prior adverse reactions from codeine. However, the doctor (or his nurse) could easily generate an incontrovertible audit trail report via the doctor's superset account. He could do this even if the patient's daughter revoked his authorization privileges on the client account following the office visit. What follows are excerpts from a relevant audit trail report.

Audit Trail Search for:

User id: 2345 (Primary care doc)

User id: 23451 (Nurse)

Client account id: 4592 (Bob Jenkins, Pt)

User id: 45921 (Susan Jenkins, legal agent)

Start date for search: 3/22/03

Data category: Medical

Show: All transactions and linked documents

Audit Trail Report:

3/22, 10 to 10:15 a.m. User id: 45921, User enters “none” in “current allergies” field. User enters “none” in “any bad reactions to medications in past” field. User enters “back pain” in “describe reason for patient's visit today” field. User enters “prescribe painkiller” in “what would you like the doctor to do for patient during this visit?” field. User enters “I don't know what to do with my father, he's driving me crazy” in the “Any other problems you'd like to talk to the doctor about today” field.

3/22, 10:20 a.m. User id: 2345. User opens “vital information” and “today's visit” in client account id 4592.

3/22, 10:40 a.m. User id: 2345. User exercises Rx privileges via superset account id 72459. Copy of prescription for “codeine” sent to “Star Pharmacy” for “customer pickup.” Message with dosage, use class of drugs) sent to Star Pharmacy for “customer acknowledgment signature” and to user id 45921 message board on user home page.

3/22, 3 p.m. User id: 45921. User accesses client account id 4592. User views message from “Dr. Sam Siegel” re “Rx for Bob Jenkins.” User clicks “yes” to “I have read and understand this information.”

What we claim is:

1. A web-based method to control access to a client-centric relational database in a computer via the Internet with the relational database containing records of named client accounts with the records stored in a multiple of different data categories each representative of a different type of information and including data functions representative of different transactional operations comprising the steps of:
establishing an identity for a client authorized user to access the relational database via the Internet represented by an assigned ID and password under the control of the client or designated agent thereof;
establishing authorization records for each of the identified client authorized users which define the access and data function privileges for such authorized user in one or more named client accounts under the control of the client or designated agent thereof;
authenticating an authorized user when accessing the relational database via the Internet by the assigned ID and password; and
opening an account user interface in response to when said relational database is accessed by an authorized user with said account user interface being limited to the access and data function privileges defined in the authorization records for each such authorized user permitting the authorized user access to information in each of the named client accounts authorized by the client or the designated agent thereof and to perform the authorized data function operations in accordance with the privileges granted to such authorized user.

2. A client-centric Internet information eSystem in which clients control user access to their client account records stored in a relational database on a computer accessible through the Internet with all database records in the relational database corresponding to a multiple number of different data categories of subjects and data functions for covering, at least, the entire spectrum of heathcare and community care informational records of each named client account and identified by a client account ID comprising:
relational database tables in said relational database to permit searching, aggregation, and statistical operations across client accounts by authorized account users of the system having such privileges;
an Internet Website that authorized account users can use to access said relational database from any Web-browser equipped device with a modem with said Website adapted to authenticate the logon ID and password for each client authorized user entering the eSystem;
means to encrypt communication between user's device modem and eSystem;
authorization records stored in the relational database defining the access and data function privileges of each authorized user in one or more of the named client accounts so as to access data categories and data functions within any or all of those account records;
means for opening an account user interface in response to when said relational database is accessed through the Internet by an authorized user with said account user interface limiting access only to accounts and data function defined in the authorization records for each such authorized user permiting the user to exercise access privileges with respect to data categories within the account and data functions for each data category and
display means for displaying the accessed information.
